(19) United States
(12) Patent Application Publication
(10) Pub. No.: US 2025/0226200 A1
(43) Pub. Date: Jul. 10, 2025

(54) SHIELD FOR ION SOURCE ENCLOSURE

(71) Applicant: Micromass UK Limited, Wilmslow (GB)

(72) Inventors: Ian Trivett, Cheadle (GB); Suloke Mathai, Macclesfield (GB); David Jones, Chester (GB)

(73) Assignee: Micromass UK Limited, Wilmslow (GB)

(21) Appl. No.: 18/843,868

(22) PCT Filed: Mar. 6, 2023
(86) PCT No.: PCT/GB2023/050523

§ 371 Date: Sep. 4, 2024

(30) Foreign Application Priority Data
Mar. 7, 2022 (GB) 2203146.2

(51) Int. Cl. H01J 49/24; G01N 27/623; H01J 49/16

(52) U.S. Cl. CPC H01J 49/24; H01J 49/165; G01N 27/623

(57) ABSTRACT

A mass and/or mobility spectrometer comprising: an ion source enclosure for housing an ion source: a vacuum chamber; a pumping block between the ion source enclosure and vacuum chamber; and a shield for protecting a surface of the ion source enclosure; wherein the shield has a first portion configured to mount to a upstream side of the pumping block so as to secure the shield at a location in which a second portion of the shield covers an internal surface of the ion source enclosure.

### CROSS-REFERENCE TO RELATED APPLICATION

This application claims priority from and the benefit of United Kingdom patent application No. 2203146.2 filed on 7 Mar. 2022. The entire contents of this application are incorporated herein by reference.

### FIELD OF THE INVENTION

The present invention relates generally to mass and/or ion mobility spectrometry and in particular to a shield that is used to protect components of the spectrometer from the ion source.

### BACKGROUND

Mass and/or mobility spectrometers comprise an ion source that receives an analyte and generates ions therefrom. For example, ion sources are known that spray a solution comprising analyte into an ion source enclosure, typically using a heated gas to assist desolvation and ionisation of the analyte. This spray impacts on the inner surfaces of the ion source enclosure, which results in contamination of these surfaces and the necessity to clean them relatively regularly. For example, solvent and/or analyte from the ion source may become deposited on these surfaces. Also, operators of the spectrometer may supply chemically aggressive materials to the ion source that are then sprayed at the surfaces and corrode them.

Although it is possible to provide a plate in the ion source enclosure to try to protect some of its surfaces, to date there has not been a satisfactory solution to the above problems.

### SUMMARY

From an first aspect, the present invention provides a mass and/or mobility spectrometer comprising: an ion source enclosure for housing an ion source; a vacuum chamber; a pumping block between the ion source enclosure and vacuum chamber; and a shield for protecting a surface of the ion source enclosure; wherein the shield has a first portion configured to mount to a upstream side of the pumping block so as to secure the shield at a location in which a second portion of the shield covers an internal surface of the ion source enclosure.

As the first shield portion secures the shield to the pumping block, the shield remains in a fixed position (relative to the pumping block) during mounting of the ion source enclosure to the pumping block. As such, the second portion of the shield remains secured in the desired position to protect an internal surface of the ion source enclosure, rather than being dislodged during mounting of the ion source enclosure against the pumping block.

The first portion of the shield may be directly connected to the pumping block, i.e. the first portion may directly engage the pumping block.

The ion source enclosure may be arranged on a door that is hingedly coupled relative to the pumping block, such that when the door is closed the ion source enclosure is sealed against the pumping block.

The spectrometer includes an ion source which is located such that at least a portion of the ion source is arranged within the ion source enclosure. For example, the ion source may be located on, or protrude through, a wall of the ion source enclosure such that ions are generated by the ion source within the ion source enclosure.

The ion source may be an atmospheric pressure ionisation ion source. However, it is contemplated that vacuum pressure ion sources could be used by pumping down the ion source enclosure to a vacuum pressure.

The spectrometer may comprise said ion source, wherein the ion source is configured to receive a liquid solution comprising analyte carried in a solvent and to spray the solution into the ion source enclosure. Optionally, the ion source is configured to use a nebuliser gas to nebulise the sprayed sample and/or to supply a heated gas to desolvate the sprayed sample.

The ion source may be, for example, an ElectroSpray Ionisation (ESI) ion source, although other types of ion sources are also contemplated, including those that do not spray into the ion source enclosure.

The first portion of the shield may comprise a substantially planar region for being placed against or adjacent a planar region of said upstream wall of the pumping block for protecting said planar region of the wall from the ion source.

The upstream wall of the pumping block may comprise a generally planar region and a tubular portion extending upstream from the planar region, wherein the tubular portion comprises an ion conduit for allowing ions from the ion source to pass through the pumping block to the vacuum chamber; and wherein the first portion of the shield is configured to mount to the tubular portion.

The first portion of the shield may be configured to at least partially surround the circumference of the tubular portion. For example, the first portion of the shield may be substantially C-shaped. This enables the first portion of the shield to be slotted in place around the tubular portion.

The first shield portion may be configured to hang from the tubular portion. For example the first shield portion may contact and rest on a vertically upper side of the tubular portion such that the first shield portion can hang from the tubular portion under the effect of gravity.

The first portion of the shield may comprise at least one engagement member for engaging the tubular portion so as to maintain the first portion of the shield in place on the tubular portion. Optionally, the at least one engagement member is configured to clamp the first portion of the shield to the tubular member.

For example, each at least one engagement member may be a resiliently biased member that urges against the tubular portion, such as a sprung component.

The at least one engagement member may be a spring clip, e.g. formed from bent sheet metal. The spring clip may be releasably connectable and disconnectable with the rest of the first shield portion, such that they can be repeatedly connected with, and disconnected from, each other. This may be enabled by the first shield portion having forked prongs such that the spring clip can be slid into and out of the gaps between the forked prongs. As the spring clip is separable from the first portion of the shield it enables cleaning of the shield components to be performed more easily. Also, this allows the spring clip to be constructed from a different material to the first portion of the shield, so that the two components can be formed from the optimum materials for their different functions.

The tubular portion of the pumping block may have one or more non-cylindrical portion and a perimeter of the first portion of the shield may have one or more non-circular region that is configured to abut and engage the one or more non-cylindrical portion of the tubular portion so as to prevent the first portion of the shield rotating circumferentially relative to the tubular portion.

The spectrometer may comprise said ion source, wherein the ion source is configured to receive a liquid solution comprising analyte carried in a solvent and spray the solution into the ion source enclosure; and wherein the ion source is arranged so as to spray the solution along an axis that is directly towards and onto the second portion of the shield.

The second portion of the shield may be spaced apart from the ion source enclosure, when the ion source enclosure is mounted against the pumping block.

The second portion of the shield may not contact the ion source enclosure when the ion source enclosure is mounted against the pumping block.

The shield may be mounted to the pumping block such that there is a gap between the second portion of the shield and an adjacent wall of the ion source enclosure, when the ion source enclosure is mounted against the pumping block, optionally wherein the gap is ≤2 mm or ≤1 mm.

The second portion of the shield may comprise a curved plate and covers a curved wall of the ion source enclosure that is adjacent to the second portion of the shield.

The second portion of the shield may cover the bottom region of the internal wall of the ion source enclosure. The second portion of the shield may therefore have a curved profile that complements a curved profile of the circumferentially extending bottom wall of the ion source enclosure.

The first shield portion may have a substantially planar region for covering a planar region of the upstream wall of the pumping block, and major surfaces of the curved plate may be substantially perpendicular to major surfaces of the planar region of the first portion of the shield.

The ion source may have a probe tip that has an outlet through which the analyte passes. The outlet end of the probe tip may be arranged in the vertically upper side of the ion source enclosure.

The second portion of the shield may be arranged adjacent to and covering a bottom wall portion of the ion source enclosure; and an upper side of the second portion of the shield may have one or more channels or upwardly facing lips for directing liquid along the second portion of the shield.

For the avoidance of doubt, the upper side of the second portion of the shield is the side that faces away from the bottom wall portion.

Any one of these upwardly facing lips, or channels, may be formed by folding parts of the second portion of the shield upwards, or by pressing a groove in the lower face of the second portion of the shield.

The spectrometer may comprise a waste conduit in the pumping block for allowing waste gas and/or liquid from the ion source to pass out of the ion source enclosure; wherein the second portion of the shield extends along the bottom wall portion of the ion source enclosure, from a first end that is located at an entrance opening of the waste conduit, to a second end that is positioned vertically higher than the first end.

The second portion of the shield extends circumferentially along the bottom wall portion of the ion source enclosure, i.e. the direction from the first end to the second end is orthogonal to the (planar) upstream side of the pumping block.

The ion source enclosure may be configured to be sealable against the pumping block so as to form an ion source chamber. The waste gas and/or liquid may only be able to exit the ion source chamber via the waste conduit (other than via an ion conduit through the pumping block for allowing ions to pass from the ion source into the vacuum chamber).

The opening to the waste conduit may be adjacent a lowermost internal surface of the ion source enclosure. In this manner, the waste liquid solvent may drain out of the ion source enclosure by means of gravity.

The ion source may be configured to receive a liquid solution comprising analyte carried in a solvent and to spray the solution into the ion source enclosure; wherein the second portion of the shield is configured and located relative to an exit axis of the ion source such that the central axis of the spray contacts the second portion of the shield at an acute angle to the second portion of the shield, at the point of impact, such that the second portion of the shield directs the spray along the shield towards the opening of the waste conduit.

The first end of the second portion of the shield may protrude into the opening of the waste conduit.

The second portion of the shield may bridge an interface between the ion source enclosure and the pumping block, and passes into the waste conduit for preventing liquid from the ion source dripping into the interface.

The first and second portions of the shield may be releasably connectable with each other, such that they can be repeatedly connected and disconnected with each other.

Each of the first and second portions of the shield may have at least one interlocking element that is configured to cooperate with at least one interlocking element on the second and first portions of the shield, respectively, such that the first and second portions of the shield can be repeatedly mechanically engaged with, and disengaged from, each other.

The first or second portion of the shield may have a first interlocking element for engaging the second or first shield portion of the shield, respectively, so as to prevent the first and second shield portions of the shield from moving away from each other in a first dimension.

Optionally, the first or second shield portion of the shield has a second interlocking element for engaging the second or first shield portion of the shield, respectively, so as to prevent the first and second shield portions of the shield from moving away from each other in a second dimension that is orthogonal to the first dimension.

Optionally, the first or second shield portion of the shield has a third interlocking element for engaging the second or first shield portion of the shield, respectively, so as to prevent the first and second shield portions of the shield from moving away from each other in a third dimension that is orthogonal to the first and second dimensions.

Any one of the first and/or second and/or third interlocking element may be a hook formed by cutting a flap in a planar region of the first or second portion of the shield and then bending that flap out of the plane of the planar region so as to form the hook.

The first portion of the shield may have a mechanical locating member arranged and located around positions on the first portion of the shield that the second portion of the shield abuts against when it is engaged with the first portion of the shield.

The mechanical locating member may be a ridge that extends around at least part of the perimeter of the part of the second portion of the shield that abuts against the first portion of the shield when they are engaged. Optionally, the ridge has been formed by pressing a groove into the side of the first portion of the shield that is opposite to the side against which the second portion of the shield abuts.

The first and/or second portion of the shield may be formed from metal except for a grip region that is formed from, or covered by, a thermally insulating material.
The thermally insulating material may be a polymer or plastic, such as PEEK.

The present invention also provides a shield for an ion source enclosure, wherein the shield has a first portion configured to mount to an upstream side of a pumping block of a mass and/or mobility spectrometer so as to secure the shield at a location in which a second portion of the shield covers an internal surface of the ion source enclosure.

The shield may have any of the features described herein, without being limited to the other features of the spectrometer.

The present invention also provides a method of using the shield described herein. As such the present invention provides a method of mass and/or mobility spectrometry comprising: providing a shield as described herein; mounting the first portion of the shield to the upstream side of a pumping block of a mass and/or mobility spectrometer; and mounting an ion source enclosure over the shield and against the pumping block such that an internal surface of the ion source enclosure is covered by the second portion of the shield.

Less preferably, the shield may be configured to only protect the pumping block and not the ion source enclosure.

As such, the present invention also provides a mass and/or mobility spectrometer comprising: an ion source enclosure for housing an ion source; a vacuum chamber; a pumping block between the ion source enclosure and vacuum chamber; and a shield for protecting a surface of the pumping block; wherein the shield is configured to mount to an upstream side of the pumping block so as to secure the shield at a location in which it covers a surface of the pumping block.

The shield may have any of the features described herein in relation to the first portion of the shield, without requiring the second portion of the shield.

The present invention also provides an ion source shield, wherein the shield is configured to mount to an upstream side of a pumping block of a mass and/or mobility spectrometer so as to secure the shield at a location in which it covers the upstream side of the pumping block.

The present invention also provides a method of using this shield. As such the present invention provides a method of mass and/or mobility spectrometry comprising: providing a shield as described above; mounting the shield to the upstream side of a pumping block of a mass and/or mobility spectrometer; and mounting an ion source enclosure over the shield and against the pumping block.

### BRIEF DESCRIPTION OF THE DRAWINGS

Various embodiments together with other arrangements given for illustrative purposes only will now be described, by way of example only, and with reference to the accompanying drawings in which:

FIG. 1A shows a front view of a mass spectrometer according to an embodiment of the present invention, whereas FIG. 1B shows a perspective view of the spectrometer;

FIG. 2 shows a cross section of the portion of the mass spectrometer near the upstream end;

FIGS. 3A-3C show different views of an upstream portion of the spectrometer that is shown in FIGS. 1-2;

FIG. 4 shows an embodiment of a clamping member for clamping the shield to the pumping block;

FIGS. 5A-5D show different views of the ion source enclosure region;

FIGS. 6A-6B show views in which first and second portions of the shield are disengaged from each other and engaged with each other, respectively; and

FIG. 7 shows a further view of an embodiment in which the second portion of the shield is shaped to allow access to a handle for the sampling cone.

### DETAILED DESCRIPTION

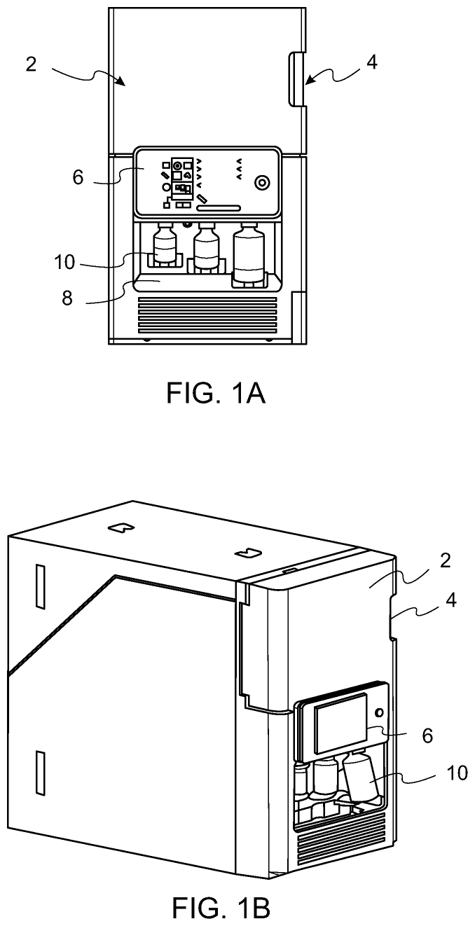

FIG. 1A shows a front view of a mass spectrometer according to an embodiment of the present invention, whereas FIG. 1B shows a perspective view of the spectrometer. The external housing of the spectrometer comprises a door 2 that is openable so as to enable access to internal components, including an ion source for ionising an analyte that is supplied to the spectrometer. The door 2 may be hinged on one side and may include a hand grip portion 4 on the opposite side that facilitates the user to pull open the door 2 with their hand. In the illustrated embodiment the hand grip portion 4 is a recessed portion of the door, but it will be appreciated that the hand grip portion may take other forms, such as a protruding handle.

In the embodiment shown, the external housing of the mass spectrometer has a display panel 6 for use in controlling the operation of the spectrometer. Also, the housing has a recessed shelf 8 on which solvent bottles 10 are shown as being located. However, it will be appreciated that the external housing need not comprise the display panel 6 and/or the recessed shelf 8 for the bottles 10.

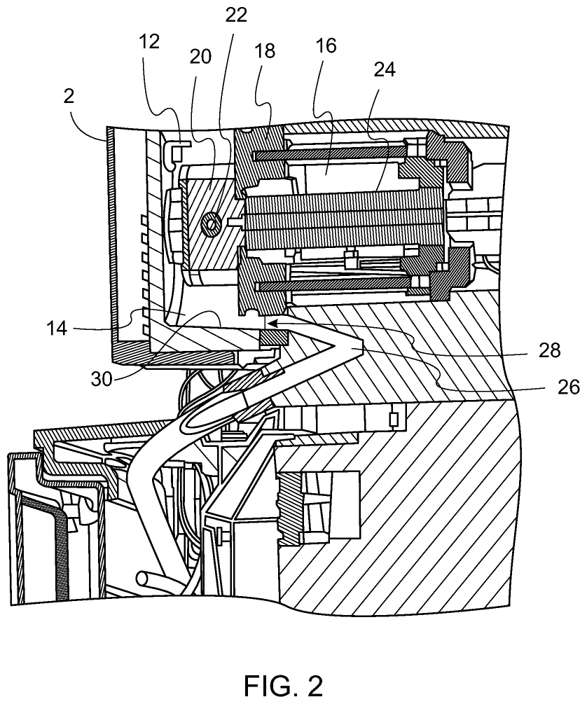

FIG. 2 shows a cross section of the portion of the mass spectrometer near the upstream end, i.e. near the door 2 and ion source. As shown in FIG. 2, the mass spectrometer comprises an ion source having a probe tip 12 that is located in an ion source enclosure 14. The ion source enclosure 14 is separated from a vacuum housing 16 by a pumping block 18, such that in use the vacuum housing 16 can be pumped down to a relatively low pressure, whereas the ion source enclosure 14 remains at a higher pressure. The spectrometer also includes an ion block 20, which acts as the interface between the ion source enclosure 14 and the vacuum housing 16. The ion block 20 has a sampling orifice 22 that receives ions that are generated by the ion source 12. The ions are able to pass through the sampling orifice 22 and into the vacuum housing 16, optionally assisted by applying an electric field in the spectrometer. Various ion-optical devices are located within the vacuum housing 16 for manipulating and analysing the ions. One such ion-optical device is the ion guide 24 shown in FIG. 2. which receives ions from the sampling orifice 22 and guides them downstream through the vacuum chamber 16 to other ion-optical devices (not shown), such as a mass filter, ion mobility separator and mass analyser.

The mass spectrometer also includes a waste conduit 26 for directing gas and solvent waste out of the ion source enclosure 14, as will be described in more detail below. In the depicted embodiment the ion source enclosure 14 remains substantially at atmospheric pressure and the ion source is therefore an atmospheric pressure ionisation (API) ion source. However, it is contemplated that vacuum pressure ion sources could be used by pumping down the ion source enclosure to a vacuum pressure.

During operation, the ion source may receive a liquid solution comprising analyte carried in a solvent and may be configured to desolvate the solution so as to produce ionised analyte. The ion source may also use a nebulising gas and/or a heated gas in order to nebulise and/or heat the analyte solution, so as to assist in the desolvation and ionisation of the analyte. The nebulising gas itself may be a heated gas. The ion source may be, for example, an ElectroSpray Ionisation (ESI) ion source, although other types of ion sources are also contemplated. As such, it is required to exhaust waste gas and also some waste liquid solvent from the ion source enclosure 14 via the waste conduit 26. The entrance opening 28 of the waste conduit 26 may be adjacent a lowermost internal surface 30 of the ion source enclosure 14. In this manner, the waste liquid solvent may drain out of the ion source enclosure 14 by means of gravity. As shown in FIG. 2, the entrance opening 28 of the waste conduit 26 may be an aperture at a rearmost (downstream) end of the ion source enclosure 14.

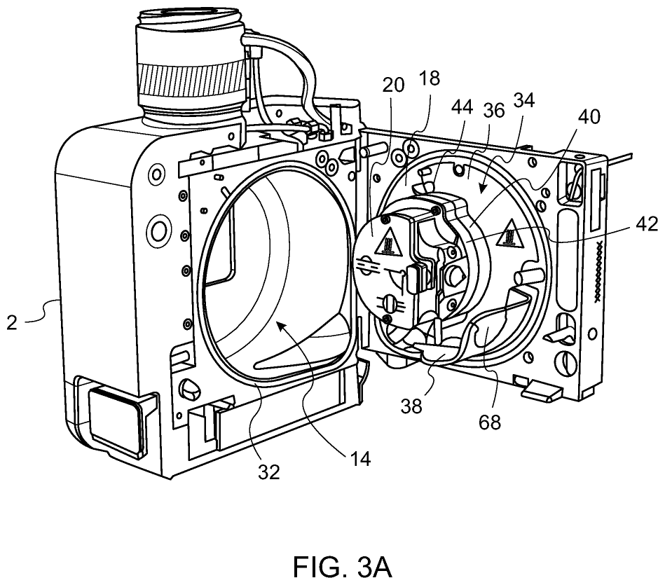

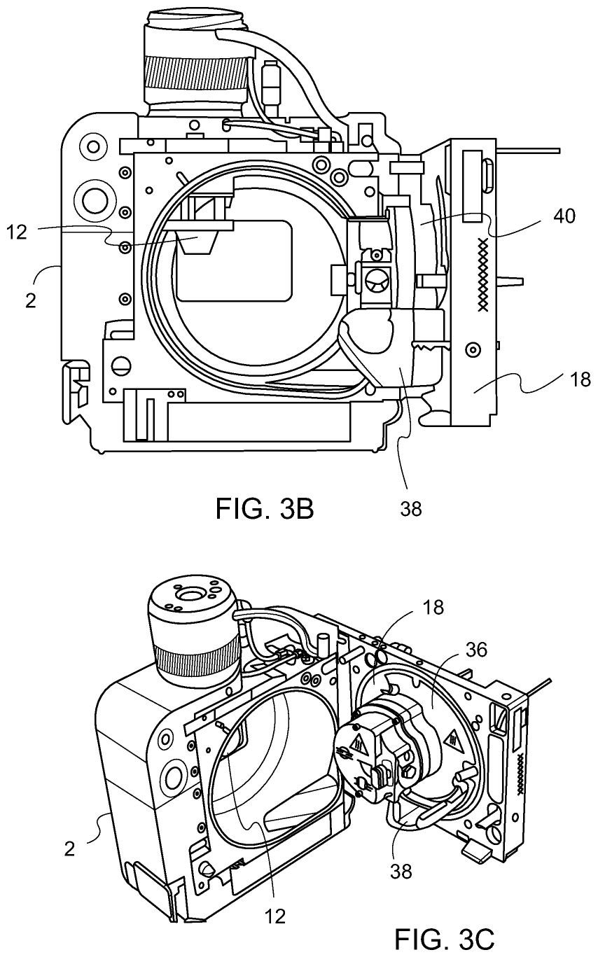

FIGS. 3A-3C show different views of an upstream portion of the spectrometer that is shown in FIGS. 1-2. In particular, FIGS. 3A-3C show the pumping block 18 that is located at the upstream end of the vacuum chamber 16, and components upstream thereof. In other words, FIGS. 3A-3C show the pumping block 18, ion block 20, ion source enclosure 14, ion source probe tip 12 and door 2. As can be seen, the ion source enclosure 14 may form part of the door 2, such that when the door 2 is opened the ion source enclosure 14 is removed from and moved away from the ion block 20 and pumping block 18, thereby uncovering the ion block 20. In contrast, when the door 2 is closed the ion source enclosure 14 surrounds and covers the ion block 20 such that the ion block is encapsulated by the ion source enclosure 14 and the pumping block 20. A seal 32 is provided on the door 2, circumferentially around the ion source enclosure 14, such that when the door 2 is closed the seal 32 abuts the pumping block 18 and prevents gases passing in or out of the ion source enclosure 14 (other than via the ion source 12, waste conduit 26 and sampling orifice 22). It is contemplated that the seal 32 could be provided on the pumping block 18, rather than on the door 2 so as to perform the same function.

As described above, the ion source probe tip 12 sprays a solution comprising analyte into the ion source enclosure 14, optionally using a heated gas to assist desolvation and ionisation of the analyte. Conventionally this spray and hot gas is directed such that it impacts on the inner surfaces of the ion source enclosure 14 and pumping block 18, which results in contamination of these surfaces and the necessity to clean them relatively regularly. For example, solvent and/or analyte from the ion source may become deposited on these surfaces. Also, operators of the spectrometer may supply chemically aggressive materials to the ion source that are then sprayed at the surfaces and corrode them. Although it is possible to provide a plate in the ion source enclosure 14 to try to protect some of its surfaces, to date there has not been a satisfactory solution to the above problems.

Embodiments of the present invention provide a shield 34 for protecting the internal surfaces of the ion source enclosure 14 and the upstream surface of the pumping block 18 from the ion source spray. FIGS. 3A-3C show an embodiment of the shield 34.

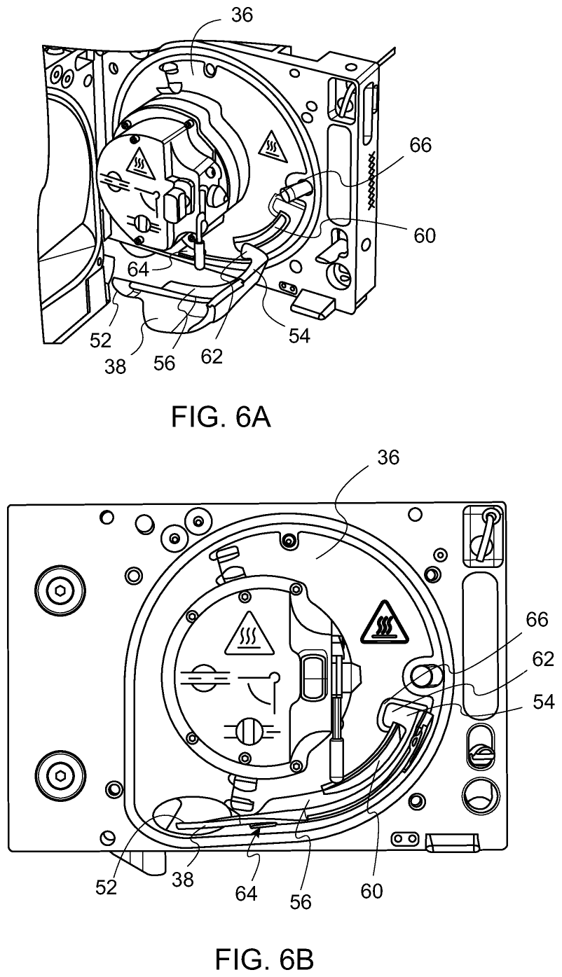

The shield 34 comprises a first portion 36 that is configured to protect the pumping block 18, and a second portion 38 that is configured to protect the ion source enclosure 14. The second portion 38 may also be configured to perform additional functions, such as directing waste gas and solvent to the waste conduit 26, as will be described further below. The first and second shield portions 36,38 may be releasably connectable with each other, such that they can be repeatedly connected and disconnected with each other, as will be described in more detail further below in relation to FIGS. 6A-6B.

The first shield portion 36 maybe substantially planar, at least on the downstream side, such that the planar region can be placed against the upstream wall of the pumping block 18 so as to protect it from the spray from the ion source 12. The pumping block 18 may have a generally planar upstream surface, although it may comprise a tubular flanged portion 40 that extends upstream from the planar surface, wherein the ion block 20 is mounted on the tubular portion 40 (optionally with a thermal insulating layer 42 therebetween). The tubular portion 40 of the pumping block 18 may include a conduit through which the ions can pass when travelling from the ion block 20 to the vacuum chamber 16.

The first shield portion 36 may be configured to at least partially surround the circumference of the tubular portion 40. For example, the first shield portion 36 may be substantially C-shaped. This enables the first portion 36 to be slotted in place around the tubular portion 40. The first shield portion 36 may be configured to hang from the tubular portion 40. For example the first shield portion 36 may contact and rest on a vertically upper side of the tubular portion 40 such that the first shield portion 36 can hang from the tubular portion under the effect of gravity.

The first shield portion 36 may also be provided with an engagement member 44 for engaging the tubular portion 40 so as to maintain the first shield portion 36 in place on the tubular portion 40. For example, a clamping member 44 may be provided on the first shield portion 36 for engaging a first location on the tubular member 40, and the first shield portion may be configured to extend circumferentially around the tubular portion to a second location on the tubular member that is opposite to the first location on the tubular member. The clamping member 44 is configured such that the first shield portion 36 clamps to the tubular member 40 at the first and second locations. For example, the clamping member 44 may be a resiliently biased member that urges against the tubular portion 40, such as a spring loaded component. As such, the shield is held securely in place, e.g. even during the closing and opening of the source enclosure 14, without the need for the use of any tools to mount the shield 34. This also enables the shield 34 to be retrofitted to spectrometers.

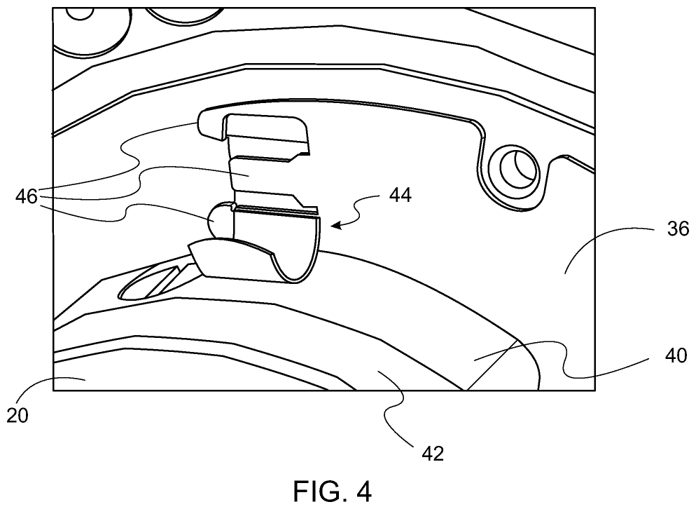

FIG. 4 shows an embodiment of the clamping member 44. The clamping member may be spring clip, e.g. formed from bent sheet metal. The spring clip may be releasably connectable and disconnectable with the rest of the first shield portion 36, such that they can be repeatedly connected with, and disconnected from, each other. In embodiments this may be enabled by the first shield portion 36 having forked prongs 46 such that the spring clip can be slid into and out of the gaps between the forked prongs. As the spring clip 44 is separable from the first shield portion 36 it enables cleaning of the shield components 36,44 to be performed more easily. Also, this allows the spring clip to be constructed from a different material to the first shield portion, so that the two components can be formed from the optimum materials for their different functions.

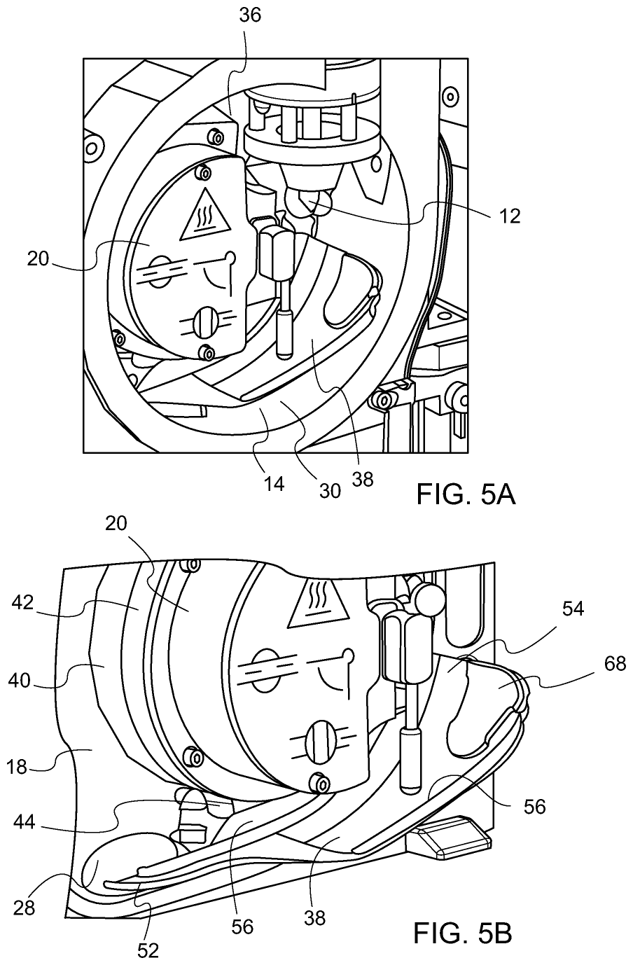

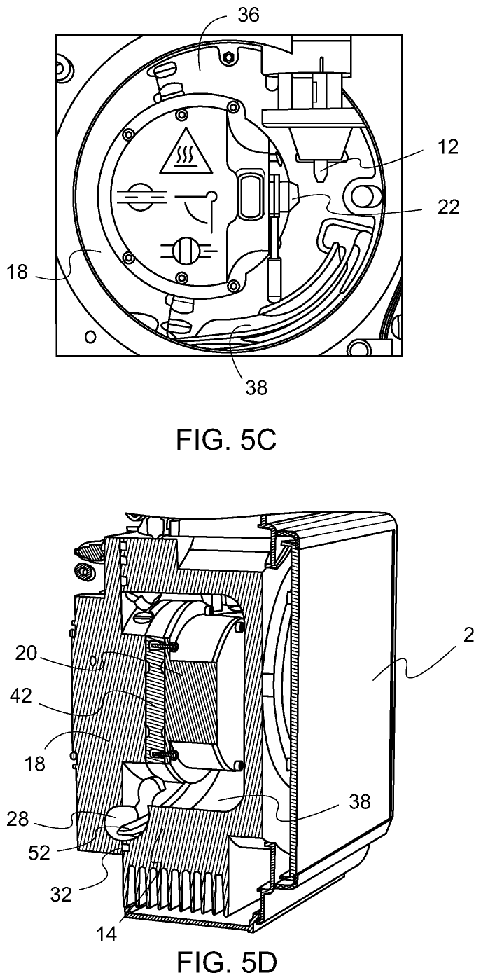

It is contemplated that the first shield portion 36 may be provided with one or more further engagement member of the type described above, for engaging the tubular portion 40 so as to maintain the first shield portion 36 in place on the tubular portion. The first shield portion 36 may therefore include multiple engagement members 44 spaced circumferentially along the perimeter of the first shield portion 36 that abuts against the tubular portion 40. For example, a second engaging member 44 may be provided on the first shield portion 36 for engaging the tubular member 40 at the second location (as best shown in FIG. 5B).

As can be seen in FIG. 3A, the tubular portion 40 of the pumping block 18 may not be perfectly cylindrical around its circumferential surface, but may have one or more non-cylindrical portion. The perimeter of the first shield member 36 that abuts against the tubular portion 40 may have one or more non-circular portion that is configured to abut and engage the one or more non-cylindrical portion of the tubular so as to prevent the first shield portion rotating circumferentially relative to the tubular.

Although the engagement member(s) 44 has been described as engaging the tubular portion 40 of the pumping block 18, it may instead engage the ion block 20 or the insulating layer 42 (e.g. if the tubular flanged portion 40 and/or insulating layer 42 is not present).

FIGS. 5A-5D show different views of the ion source enclosure region. FIGS. 5A, 5C and 5D show views in the configuration with the ion source enclosure 14 mounted over the ion block 20. In FIGS. 5A and 5C the door 2 and upstream end of the source enclosure 14 are not illustrated, so that the positions of the components can be seen easily. FIG. 5B shows a view in the configuration in which the ion source enclosure 14 is not mounted over the ion block 20.

The ion source probe tip 12 may be positioned so that the ion source sprays the analyte along an axis that passes the sampling orifice 22 in the ion block 20, e.g. such that the spray axis is orthogonal to the axis through the sampling orifice 22. The spray axis may be directly towards the second shield portion 38. The outlet end of the ion source probe tip 12 may therefore be arranged in the vertically upper side of the ion source enclosure 14, whereas the second shield portion 38 may be arranged adjacent and protecting the vertically lower side 30 of the ion source enclosure 14.

The second shield portion 38 may be a curved plate that extends in an upstream direction from the first shield portion 36 (when connected thereto and arranged in the spectrometer). More specifically, the major surfaces of the second shield portion 38 may be substantially perpendicular to the major surfaces of the first shield portion 36. The second shield portion 38 is configured such that, when the shield 34 is mounted to the pumping block 18 and within the ion source enclosure 14, the second shield portion 38 covers the lower wall 30 of the ion source enclosure and prevents the spray from the ion source 12 impacting on the lower wall. The second shield portion 38 desirably mimics the profile of the lower wall 30 of the ion source enclosure. This minimises the disruption to the gas flow within the ion source enclosure 14 which is, for example, particularly helpful if the shield 34 is retrofitted to a spectrometer that was not designed to have the shield. The second shield portion 38 may therefore have a curved profile that complements the curved profile of the circumferentially extending lower wall 30 of the ion source enclosure 14.

The second shield portion 38 may be configured to sit on the lower wall 30 of the ion source enclosure 14, when the shield 34 is connected to the spectrometer. However, desirably the second shield portion 38 is configured to sit close to the lower wall 30 of the ion source enclosure but with a gap therebetween, when the shield 34 is connected to the spectrometer. This assists with connecting and removing the ion source enclosure 14 from the pumping block 18. As the second shield portion 38 desirably mimics the lower wall 30 of the ion source enclosure 14, the gap is desirably relatively small, such as being ≤2 mm or ≤1 mm. However, less preferably the gap may be slightly larger, such as being ≤5 mm, ≤4 mm or ≤3 mm.

As best shown in FIG. 5B, the second shield portion 38 extends circumferentially around the lower wall 30 of the ion source enclosure 14 from a first end 52, which may be located at the entrance 28 to the waste conduit 26, to a second end 54 that is positioned vertically higher than the first end 52. As such, liquid solvent from the ion source 12 that impacts on the second shield portion 38 is caused to drain along the shield 34 and into the waste conduit 26. The second shield portion 38 is configured and located relative to the exit axis of the ion source 12 such that the central axis of the spray contacts the second shield portion 38 at an acute angle to the second shield portion (at the point of impact), such that the second shield portion directs the spray along the shield towards waste conduit, i.e. from the second end 54 to the first end 52 of the second shield portion 38. The upper side of the second shield portion 38 (i.e. facing the ion source 12) may have one or more channels or upwardly facing lips 56 that extend circumferentially around the ion 15 source enclosure 14, from the second end 54 to the first end 52, so as to prevent or inhibit liquid from leaving the second shield portion 38 in a direction orthogonal to the plane of the planar first shield portion 36. This helps to guide the liquid to the waste conduit opening 26. Any one of these upwardly facing lips 56 may be formed by folding parts of the second shield portion 38 upwards or by pressing a groove in the lower face of the second shield portion. 20

The second end 54 of the second shield portion 36 may protrude into and through the waste conduit opening 28. As best shown in FIG. 5D, the second shield portion 38 therefore bridges the interface between the ion source enclosure 14 and the pumping block 18 so as to prevent solvent dripping between the interface, which would require cleaning and may degrade the seal 32 therebetween. 25

FIGS. 6A-6B show views in which the first and second portions 36,38 of the shield 34 are disengaged from each other and engaged with each other, respectively.

Each of the first and second shield portions 36,38 may have interlocking elements 30 that are configured to cooperate with interlocking elements on the second and first shield portions, respectively, such that the first and second shield portions can be repeatedly mechanically engaged with, and disengaged from, each other, preferably by hand and without using any tools. As the first and second shield portions 36,38 can be disengaged from each other, this enables the second shield portion 38 to be demounted from the 35 spectrometer, whilst the first shield portion 36 may be left in place. This may assist with enabling access to various parts of the spectrometer with minimal disruption to it, e.g. in order to access the entrance to the waste conduit 26. This also allows the second shield portion 38 to be removed or replaced separately to the first shield portion 36, which is beneficial as the second shield portion is likely to have a higher rate of contamination. Also, as the first and second shield portions 36,38 may be disengaged from each other 40 they may be cleaned separately and therefore more easily. This configuration also enables the first and second shield portions 36,38 to be formed from separate materials so that they may be optimised for their different locations in the ion source region, e.g. the second shield portion may need to be more durable than the first shield portion.

The first shield portion 36 may have a first hook 60 for engaging the second shield portion 38 so as to prevent the second shield portion from moving away from the first shield portion, e.g. in an axial direction that is orthogonal to the planar portion of the first shield portion. The first hook 60 may be formed by cutting a flap in a planar region of the first shield portion 36 and then bending that flap out of the plane of the planar region so as to form the first hook. The first hook 60 is desirably configured such that the direction from the base of the hook to the distal, free end of the hook is substantially vertically downwards. This may help inhibit spray from the ion source 12 getting behind the first shield portion 36 and contacting the pumping block 18 (when the spray is directed downwards), but it also enables the upwards lip 56 on the second shield portion 38 to be engaged by the hook 60.

The second shield portion 38 may comprise a second hook 62, e.g. at or proximate the second end 54, for engaging the first shield portion 36. This second hook 62 may be arranged and configured such that when the second shield portion 38 is engaged with the first hook 60, to prevent axial movement relative to each other, the second hook 62 engages the first shield portion 36 such that the second shield portion 38 hangs from the first shield portion 36. For example, the second hook 62 on the second shield portion 38 may hook onto the first hook 60 of the first shield portion 36.

The first and second shield portions 36,38 may have additional inter-engaging elements such that the second shield portion 38 is supported by the first shield portion 36. For example, the first shield portion 36 may have a protrusion 64 that the second shield portion 38 sits on, e.g. at a location proximate to the first end 52 of the second shield portion 38 when the first and second shield portions are engaged.

The first shield portion 36 may have one or more mechanical and/or visual locating member 66 arranged and located at or around the positions on the first shield portion 36 that the second shield portion 38 will abut against when it is engaged with the first shield portion. For example, the first shield portion 36 may have a ridge 66 located thereon such that the ridge extends around at least part of the perimeter of the part of the second shield portion 38 that abuts against the first shield portion 36 when they are engaged. The ridge 66 may be formed, for example, by pressing a groove into the side of the first shield portion 36 that is opposite to the side against which the second shield portion 38 abuts. These features not only help the user identify where on the first shield portion 36 the second shield portion 38 should be mounted, but they also help maintain the second shield portion 38 in place on the first shield portion 36.

Although embodiments have been described in which the first shield portion 36 has certain hooks and protrusions and the second shield portion 38 has cooperating elements, it is alternatively contemplated that the second shield portion may have said certain hooks and protrusions and the first shield portion has the cooperating elements. It is also contemplated that other means of connecting the first and second shield portions may be used. For example, less desirably, screws or bolts may be used to connect the shield portions.

The first and/or second shield portions 36,38 may be formed from a metal, such as steel (e.g. stainless steel). However, it is contemplated that the first and/or second shield portions 36,38 may be formed from a material other than metal.

The first and/or second shield portions 36,38 may be formed from sheet material, such as sheet metal, e.g. by cutting and pressing sheet material into the geometry required. However, any other technique may be used to form the first and/or second shield portions 36,38, such as computer numerical control machining, additive manufacturing, moulding or casting.

The first and/or second shield portions 36,38 may be relatively thin, which enables them to heat up relatively quickly to the desired temperature when the ion source is operating, but also to cool down relatively quickly when it is desired to remove these parts.

As best seen in FIGS. 3A and 5B, the second shield portion 38 may include a grip region 68 that is formed from, or covered by, a thermally insulating material that is different to the rest of the second shield portion. This enables the user to disengage the second shield portion 38 from the first shield portion 36 with their hands, even the second shield portion has been heated. When the thermally insulating material is a cover or coating, it may cover or coat opposing upper and lower surfaces of the second shield portion 38 and desirably also a peripheral edge of the second shield portion that connects the upper and lower surfaces. The thermally insulating material may be formed from a plastic or polymer such as PEEK. The first shield portion 36 may also include a corresponding grip region.

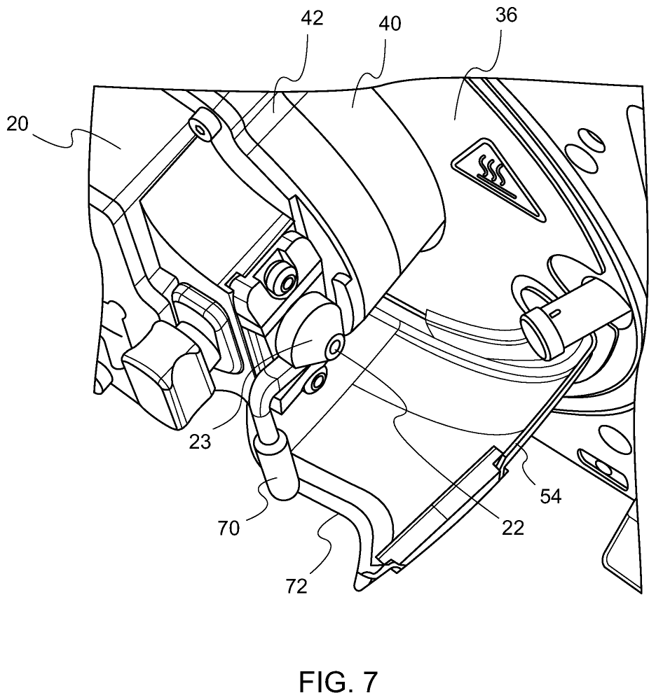

FIG. 7 shows a further view of an embodiment. As described above, the ion block 20 includes a sampling orifice 22, which is arranged in a member such as a sampling cone 23. A handle 70 may extend from the member 23 so that a user may grip the handle and remove the member from the ion block 20, e.g. to clean or replace the sampling orifice 22. The handle 70 may be a rod, protrusion or other element that can be gripped. The handle 70 may be formed from or covered by a thermally insulating material, such as PEEK, so that the sampling orifice 22 can be removed by handling the handle even when the sampling orifice is hot. The embodiment shown in FIG. 7 is the same as those described above, except wherein the upstream perimeter 72 (i.e. furthest from the pumping block 20) of the second shield portion 38 is profiled such that it does not extend beneath the handle 70 for removing and replacing the sampling cone 23. The upstream perimeter 72 of the second shield portion 38 may therefore be curved, or otherwise recessed between its first 54 and second 54 circumferential ends.

As described above, the shield 34 is configured to protect internal surfaces of the ion source enclosure 14 and the upstream surface of the pumping block 18. This reduces the amount of cleaning of these surfaces that is required and may also protect them from corrosion caused by the operation of the ion source, such as due to heat from the ion source and/or chemicals in the sample that is supplied to the ion source 12. The provision of such as shield 34 also enables said surfaces to be made from different materials to those that must conventionally be used. For example, conventionally the upstream wall of the pumping block 18 is made from aluminium, which must then be coated with PTFE, baked and polished. The use of a shield 34 according to the embodiments disclosed herein enables the surfaces protected by it to be made from other materials and/or not coated. Also, as the shield 34 covers these surfaces, the surfaces no longer need to be aesthetically pleasing and so they need not be machined and polished. For example, these surfaces could be formed from cast metals, with the shield providing the required functionality and aesthetic appeal.

Experimental testing has been performed and it was found that the mass spectral data obtained by the mass spectrometer was not affected by the presence of the shield 34 according to the embodiments disclosed herein, i.e. the mass spectral data obtained with the shield being present in the spectrometer was substantially the same as the mass spectral data obtained for the same experiment without the shield being present in the spectrometer.

Although the present invention has been described with reference to preferred embodiments, it will be understood by those skilled in the art that various changes in form and detail may be made without departing from the scope of the invention as set forth in the accompanying claims.

For example, although the shield 34 according to embodiments described above protects the internal surfaces of the ion source enclosure 14 and the upstream side of the pumping block 18, it is contemplated that the shield may only consist of the first portion 36 so as to protect the pumping block 18. Alternatively, the first portion 36 may not be configured to protect pumping block 18 but may instead simply serve as a means for connecting the second portion 38 to the spectrometer.

Additionally, or alternatively, the ion source enclosure 14 need not be mounted on a hinged door, or even mounted to a door at all.

1. A mass and/or mobility spectrometer comprising:
an ion source enclosure for housing an ion source;
a vacuum chamber;
a pumping block between the ion source enclosure and vacuum chamber; and
a shield for protecting a surface of the ion source enclosure;
wherein the shield has a first portion configured to mount to a upstream side of the pumping block so as to secure the shield at a location in which a second portion of the shield covers an internal surface of the ion source enclosure.

2. The spectrometer of claim 1, wherein the ion source enclosure is arranged on a door that is hingedly coupled relative to the pumping block, such that when the door is closed the ion source enclosure is sealed against the pumping block.

3. The spectrometer of claim 1 or 2, comprising said ion source, wherein the ion source is configured to receive a liquid solution comprising analyte carried in a solvent and to spray the solution into the ion source enclosure; and
optionally wherein the ion source is configured to use a nebuliser gas to nebulise the sprayed sample and/or to supply a heated gas to desolvate the sprayed sample.

4. The spectrometer of any preceding claim, wherein the first portion of the shield comprises a substantially planar region for being placed against or adjacent a planar region of said upstream wall of the pumping block for protecting said planar region of the wall from the ion source.

5. The spectrometer of any preceding claim, wherein the upstream wall of the pumping block comprises a generally planar region and a tubular portion extending upstream from the planar region, wherein the tubular portion comprises an ion conduit for allowing ions from the ion source to pass through the pumping block to the vacuum chamber; and wherein the first portion of the shield is configured to mount to the tubular portion.

6. The spectrometer of claim 5, wherein the first portion of the shield comprises at least one engagement member for engaging the tubular portion so as to maintain the first portion of the shield in place on the tubular portion, optionally wherein the at least one engagement member is configured to clamp the first portion of the shield to the tubular member.

7. The spectrometer of any preceding claim, comprising the ion source, wherein the ion source is configured to receive a liquid solution comprising analyte carried in a solvent and spray the solution into the ion source enclosure; and wherein the ion source is arranged so as to spray the solution along an axis that is directly towards and onto the second portion of the shield.

8. The spectrometer of any preceding claim, wherein the second portion of the shield does not contact the ion source enclosure when the ion source enclosure is mounted against the pumping block; and/or
wherein the shield is mounted to the pumping block such that there is a gap between the second portion of the shield and an adjacent wall of the ion source enclosure, when the ion source enclosure is mounted against the pumping block, optionally wherein the gap is ≤2 mm or ≤1 mm.

9. The spectrometer of any preceding claim, wherein the second portion of the shield comprises a curved plate and covers a curved wall of the ion source enclosure that is adjacent to the second portion of the shield.

10. The spectrometer of claim 9, wherein the first shield portion has a substantially planar region for covering a planar region of the upstream wall of the pumping block, and wherein major surfaces of the curved plate are substantially perpendicular to major surfaces of the planar region of the first portion of the shield.

11. The spectrometer of any preceding claim, wherein the second portion of the shield is arranged adjacent to and covering a bottom wall portion of the ion source enclosure; and
wherein an upper side of the second portion of the shield has one or more channels or upwardly facing lips for directing liquid along the second portion of the shield.

12. The spectrometer of claim 11, comprising a waste conduit in the pumping block for allowing waste gas and/or liquid from the ion source to pass out of the ion source enclosure; wherein the second portion of the shield extends along the bottom wall portion of the ion source enclosure, from a first end that is located at an entrance opening of the waste conduit, to a second end that is positioned vertically higher than the first end.

13. The spectrometer of claim 12, wherein the ion source is configured to receive a liquid solution comprising analyte carried in a solvent and to spray the solution into the ion source enclosure; wherein the second portion of the shield is configured and located relative to an exit axis of the ion source such that the central axis of the spray contacts the second portion of the shield at an acute angle to the second portion of the shield, at the point of impact, such that the second portion of the shield directs the spray along the shield towards the opening of the waste conduit.

14. The spectrometer of claim 12 or 13, wherein the first end of the second portion of the shield protrudes into the opening of the waste conduit.

15. The spectrometer of claim 14, wherein the second portion of the shield bridges an interface between the ion source enclosure and the pumping block, and passes into the waste conduit for preventing liquid from the ion source dripping into the interface.

16. The spectrometer of any preceding claim, wherein the first and second portions of the shield are releasably connectable with each other, such that they can be repeatedly connected and disconnected with each other.

17. The spectrometer of any preceding claim, wherein each of the first and second portions of the shield has at least one interlocking element that is configured to cooperate with at least one interlocking element on the second and first portions of the shield, respectively, such that the first and second portions of the shield can be repeatedly mechanically engaged with, and disengaged from, each other.

18. The spectrometer of claim 17, wherein the first or second portion of the shield has a first interlocking element for engaging the second or first shield portion of the shield, respectively, so as to prevent the first and second shield portions of the shield from moving away from each other in a first dimension; and
optionally wherein the first or second shield portion of the shield has a second interlocking element for engaging the second or first shield portion of the shield, respectively, so as to prevent the first and second shield portions of the shield from moving away from each other in a second dimension that is orthogonal to the first dimension; and
optionally wherein the first or second shield portion of the shield has a third interlocking element for engaging the second or first shield portion of the shield, respectively, so as to prevent the first and second shield portions of the shield from moving away from each other in a third dimension that is orthogonal to the first and second dimensions.

19. The spectrometer of claim 18, wherein any one of the first and/or second and/or third interlocking element is a hook formed by cutting a flap in a planar region of the first or second portion of the shield and then bending that flap out of the plane of the planar region so as to form the hook.

20. The spectrometer of any preceding claim, wherein the first portion of the shield has a mechanical locating member arranged and located around positions on the first portion of the shield that the second portion of the shield abuts against when it is engaged with the first portion of the shield.

21. The spectrometer of claim 20, wherein the mechanical locating member is a ridge that extends around at least part of the perimeter of the part of the second portion of the shield that abuts against the first portion of the shield when they are engaged;
optionally wherein the ridge has been formed by pressing a groove into the side of the first portion of the shield that is opposite to the side against which the second portion of the shield abuts.

22. The spectrometer of any preceding claim, wherein the first and/or second portion of the shield is formed from metal except for a grip region that is formed from, or covered by, a thermally insulating material.

23. A shield for an ion source enclosure, wherein the shield has a first portion configured to mount to an upstream side of a pumping block of a mass and/or mobility spectrometer so as to secure the shield at a location in which a second portion of the shield covers an internal surface of the ion source enclosure.

24. A method of mass and/or mobility spectrometry comprising:
providing a shield as claimed in claim 23;
mounting the first portion of the shield to the upstream side of a pumping block of a mass and/or mobility spectrometer; and
mounting an ion source enclosure over the shield and against the pumping block such that an internal surface of the ion source enclosure is covered by the second portion of the shield.

25. A mass and/or mobility spectrometer comprising:
an ion source enclosure for housing an ion source;
a vacuum chamber;
a pumping block between the ion source enclosure and vacuum chamber; and
a shield for protecting a surface of the pumping block;
wherein the shield is configured to mount to an upstream side of the pumping block so as to secure the shield at a location in which it covers a surface of the pumping block.
